(19) United States
(12) Patent Application Publication
(10) Pub. No.: US 2009/0013449 A1
(43) Pub. Date: Jan. 15, 2009

(54) PACIFIER SECURING DEVICE

(76) Inventor: Colleen Kahn, Mendota Heights, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/170,223

(22) Filed: Jul. 9, 2008

Related U.S. Application Data
(60) Provisional application No. 60/948,876, filed on Jul. 10, 2007.

(51) Int. Cl. A42B 1/24; A45F 5/00; A61J 17/00

(52) U.S. Cl. 2/209.13; 24/3.1; 606/234

(57) ABSTRACT

A pacifier securing device for securing a pacifier in an infant's mouth is provided. The pacifier securing device includes first and second supports that are attached on one end to a pacifier and on another end to a hat. The size, color and decorative accents on the hat are customizable based on age, size and preference of the wearer. The hat is constructed of any material approved for use in manufacturing apparel for infants. The first and second supports are constructed of any stretchy material that is approved for use in manufacturing apparel for infants. The length and width of the first and second supports varies depending on the age and size wearer as well the desired tautness of the supports. The first and second supports may be configured as one continuous elongate piece or one substantially v-shaped piece.

### RELATED APPLICATION

This application is related to Provisional Application Ser. No. 60/948,876, filed on Jul. 10, 2007, entitled “Pacifier Securing Device”, and which is relied upon for priority and incorporated herein in its entirety.

### BACKGROUND

The present invention relates to a pacifier securing device for removably securing a pacifier in an infant's mouth. The pacifier securing specifically relates to an infant hat attached to first and second supports for securing the pacifier in the infant's mouth.

Pacifiers and pacifier securing devices are well known in the prior art. Pacifiers are commonly used to sooth infants, particularly young infants who cannot otherwise sooth themselves. Infants generally become upset and cry when their pacifier falls out of their mouth. Because of their lack of motor skills, infants are generally unable to find the pacifier and reinsert it in their mouths. Depending on the situation, caregivers may have difficulty locating a pacifier that has fallen out of an infant's mouth and, once located, the lost pacifier is typically not sanitary enough to put back in the infant's mouth without first cleaning it. Accordingly, pacifier securing devices are commonly used to secure the pacifier to the infant's body or articles of clothing such that the pacifier is retained within the infant's reach and protected from falling on unsanitary objects and surfaces.

Pacifier securing devices known in the art generally include a strap with a fastening mechanism on one end and a pacifier on the other end. The pacifier can be either permanently or removably attached to the strap. Some of these devices incorporate a pacifier cover to protect the pacifier from contacting unsanitary objects and surfaces.

There are several problems that exist with these prior art devices. The fastening mechanisms disclosed in the prior art are often inadequate to keep the pacifier secured to the infant's body or articles of clothing. In addition, these fastening mechanisms are generally constructed of hard materials that can cause discomfort to the infant or child using the pacifier securing device. These fastening mechanisms can be difficult to use when layering clothing on infants, particularly in cold weather climates, because care givers may forget to move them to the top layer of clothing, it may be difficult to fasten them to outer wear fabrics and/or insulated clothing, etc. Accordingly, there is a need for a pacifier securing device that does not require a fastening mechanism to be secured to an infant's or child's body or articles of clothing.

The single straps commonly used in prior art pacifier securing devices also pose problems for infants and children using these devices. Young infants are unable to relocate a lost pacifier even when it is secured to their body or article of clothing with a single strap because they lack the large and fine motor skills necessary to grasp the pacifier and reinsert in their mouths. Thus, securing the pacifier with a single strap does not provide young infants with a viable way to reinsert the pacifier in their mouths in order to sooth themselves. Further, these types of straps can cause other problems for infants because they can become wrapped around limbs and appendages thereby impeding blood flow to the same. Thus, there exists a need for a pacifier securing device that does not require a single strap to be secured to an infant's body or articles of clothing.

In addition, the prior art discloses a pacifier securing device that includes two straps where the straps are attached to a pacifier on one end and to an infant's or child's ears at a second end. There are two problems associated with this device. First, securing the straps to an infant's or child's ear can cause discomfort to the infant or child using the device. Second, because of the relative flexibility of infant's and children's ears, securing the device to his/her ears is not a reliable way to ensure the device is secured the infant or child. Accordingly, there is a need for a pacifier securing device that reliably secures a pacifier to an infant or child's body without causing discomfort to the infant of child using the device.

In addition to the issues outlined above related to securing devices, the use of rigid plastics in pacifier components also creates potential problems. The placement or use of hard plastic components next to an infant's skin can be uncomfortable for a number of reasons. Obviously, these hard components can poke or dig into a child's skin, creating irritation. Further, as children move, roll, toss, turn, etc. pacifiers and pacifier attachment devices can end up in very strange positions. Clearly, components made of rigid plastics can become uncomfortable if positioned in unintended locations and orientations. Thus, the use of soft flexible materials in pacifier and pacifier attachment components is desirable.

### BRIEF SUMMARY OF THE INVENTION

It is an object of the present invention to provide a pacifier securing device that is not secured to an infant's body or clothing with a fastening mechanism. It is another object of the present invention to provide a pacifier securing device that uses a means other than single strap to secure the device to the infant's body. It is a third object of the present invention to provide a pacifier securing device that allows the children and/or infants the ability to sooth themselves without requiring them to use their hands to grasp the pacifier and insert it into their mouths.

The above objects, and others, are achieved by providing a pacifier holding device which is comfortable for an infant to wear, and which holds or maintains the pacifier in a readily accessible position. Further, the pacifier holding device is fabricated of appropriate material for infant use, thus addressing any comfort and safety issues that may exist. In addition, the device is easily adapted to different styles, colors or patterns, thus providing a pacifier holding device which is aesthetically pleasing.

The pacifier holding device, in one embodiment, is generally configured as a cap or hat which can easily be worn by an infant. This cap then has a pair of connecting straps attached thereto and extend downwardly. In use, these straps are configured to be placed approximately at or above the ears of the infant, thus extending downwardly on the sides of the infant's head. Attached to an opposite end of these connection straps is the pacifier. More significantly, the pacifier is loosely held in a position to be adjacent to the infant's mouth, thus being readily accessible to the infant without extreme searching or fumbling. This is particularly advantageous as infants typically lack the motor skills to find and reinsert a pacifier once it falls out of their mouths.

In alternative embodiments, the connection straps extending downwardly from the cap are also configured to double as a chin strap. In this particular embodiment, the strap will extend down below the infant's chin, while also providing attachment accommodations for holding the pacifier. Again, this allows the pacifier to be held in a convenient and readily accessible position.

In an another alternative embodiment, an attachment mechanism or keeper is utilized which is designed to then be attached to a pacifier. In this embodiment, the keeper is attached to the cap via the supports. The keeper is then capable of holding and removably attaching the pacifier. Using this attachment scheme, the pacifier can then be removed from the pacifier securing device when desired.

In each of the above-referenced various embodiments, and in other alternatives, the connection straps are removably attached via typical connection devices. For example, these connection devices may include snaps, hook-and-loop material (e.g. Velcro), buttons, etc. Removal is beneficial to allow cleaning when appropriate, and also providing ease of use.

### BRIEF DESCRIPTION OF THE DRAWINGS

Further objects and advantages of the present invention can be seen from the detailed description and the following drawing figures, in which:

FIG. 1 is a front view of the pacifier securing device of the present invention;

FIG. 2 is a side view of the pacifier securing device of the present invention;

FIG. 3 is an alternate front view of the pacifier securing device of the present invention;

FIG. 4 is an alternate side view of the pacifier securing device of the present invention; and

FIG. 5 is a perspective view of an alternative connecting device.

### DETAILED DESCRIPTION OF THE INVENTION

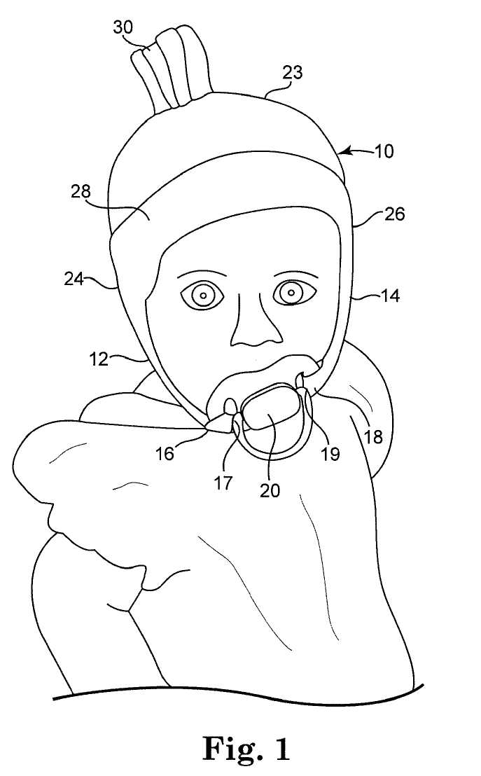

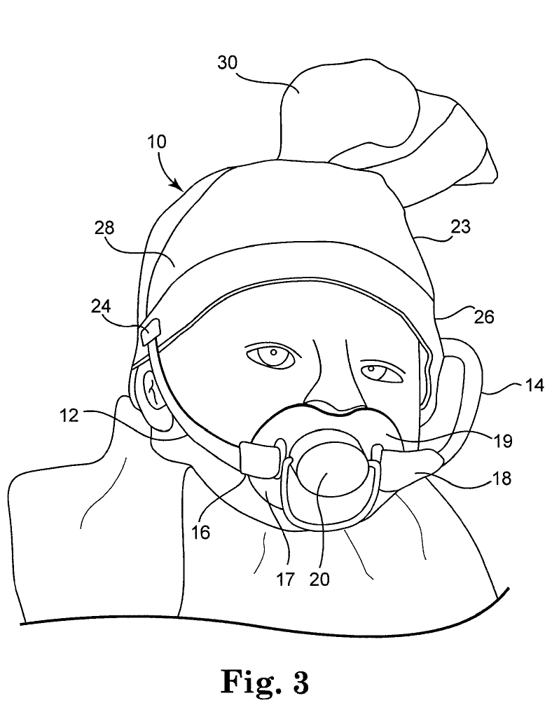

Referring to FIGS. 1 and 3, there is shown a pacifier securing device 10 of the present invention. For purposes of this disclosure, the term “infant” is defined as any individual who routinely uses a pacifier, including new born infants, children and the like. There is shown a first strap or support 12 and a second strap or support 14. A first end 16 of the first support 12 is attached to a first side 17 of a pacifier 20. A first end 18 of the second support 14 is attached to a second side 19 of the pacifier 20. A second end 21 of the first support 12 is attached to a first attachment point 24 on a hat 23. A second end 22 of the second support 14 is attached to a second attachment point 26 on the hat 23. It should be noted that the references above to attachment is meant to cover both permanently attached and removably attached. For example, solid sewn on attachments are one possibility, while snaps, hook-and-loop material, buttons and other removable attachment methods may be utilized.

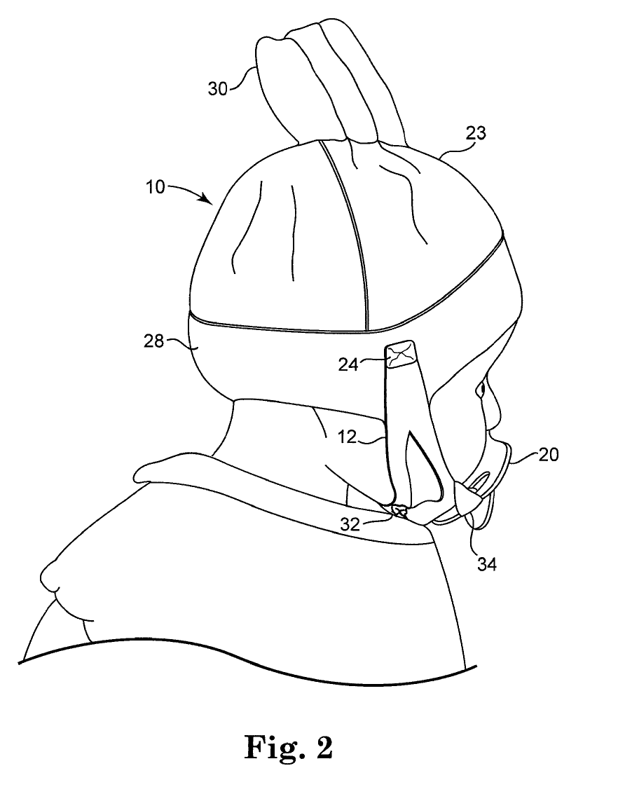

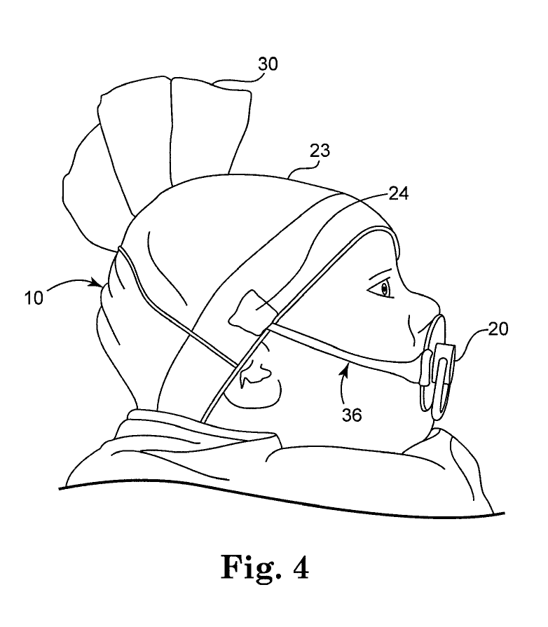

The first support 12 and second support 14 are constructed of any stretchy material that is authorized for use in the manufacture of clothing for infants. The first and second supports 12, 14 may be any color, including patterned designs. In addition, the length and width of the first and second supports 12, 14 vary depending on the age and size of the infant for whom the pacifier securing device 10 is created. Preferably, the material used for first and second supports 12, 14, is soft and flexible to avoid irritation to the child. In addition, and comparing FIG. 1 with FIG. 3, the length and width of the first and second supports 12, 14 vary depending on the desired tautness of the supports 12, 14. For example, in FIG. 3, the support 12 or 14 is depicted as being very loose. Alternatively, in FIG. 1, the support 12 or 14 is depicted as being relatively taut. In addition, in FIG. 2, the support 12 or 14 is substantially v-shaped, whereas in FIG. 4, the support 12 or 14 is one continuous elongate piece of material. Further, FIG. 2 illustrates how the ends of the straps under the chin can be connected or configured to provide both a chin strap and a pacifier holding strap.

In one embodiment of the present invention, the first ends 16, 18 of the first and second supports 12, 14 are fixedly attached to the pacifier 20. In this embodiment, the first and second supports 16, 18 must be washable to the same extent as the pacifier 20 to ensure that they are sufficiently sanitary to contact the infant's mouth.

In an alternate embodiment of the present invention, the first ends 16, 18 of the first and second supports 12, 14 are removably attached to the pacifier 20 via a fastener. The fastener includes but is not limited to snaps, buttons, hook-and-loop material (e.g. Velcro), ties, zippers, and the like.

Referring now to FIGS. 2 and 4, in one embodiment, the first and second ends 21, 22 of the first and second supports 12, 14 are fixedly attached to the first and second attachment points 24, 26 on the hat 23. Alternatively, the first and second ends 21, 22 of the first and second supports 12, 14 are removably attached to the first and second attachment points 24, 26 on the hat 23 via a fastener. Again, the fastener includes but is not limited to snaps, buttons, Velcro, ties, zippers, and the like. It is noted that hat 23 shown in the various figures include a headband and an upper portion. It is contemplated that hat 23 could be configured with or without this headband, depending on the desired styling.

Referring now to FIG. 2, in one embodiment of the present invention, the first and second supports 12, 14 have a substantially v-shaped construction including a first piece of material 32 and a second piece of material 34. The first piece of material 32 of the first support 12 is fitted under the infant's chin such that it can be connected to the first piece of material 32 of the second support 14. In one embodiment, the first piece of material 32 of the first and second supports 12, 14 are fixedly connected to one another. In another embodiment, the first piece of material 32 of the first and second supports 12, 14 are removably connected to one another via a fastener, where the fastener includes but is not limited to snaps, buttons, Velcro, ties, zippers, and the like. Still referring to FIG. 2, the second pieces of material 34 of the first and second supports 12, 14 are attached to the pacifier 20 according to the means previously discussed.

Referring now to FIG. 4, in an alternate embodiment, the first and second supports 12, 14 are generally one continuous elongate piece, or a single piece 36 of material. The single piece 36 of material is connected on one end to the pacifier 20 and on the other end to the hat 23 according to the means previously discussed.

Referring to FIGS. 1-4, the size of the hat 23 varies according to the age and size of the wearer. The hat 23 is constructed of any material that is approved for use in the manufacture of clothing for infants. The design of the hat 23 is customizable. For example, the color of the hat 23 may vary, including various patterned designs. A band 28 around the lower circumference of the hat is customizable with alternate colors, patterns, monogramming, and the like. In addition, a decorative accent 30 can be placed on the hat.

In operation, referring again to FIGS. 1-4, in one embodiment, the hat 23 is fitted on an infant's head. The second end 21 of the first support 12 is attached to the first attachment point 24 on the hat 23. The second end 22 of the second support 14 is attached to the second attachment point 26 on the hat 23. The first side 17 of the pacifier 20 is attached to the first end 16 of the first support 12. The second side 19 of the pacifier 20 is attached to the first end 18 of the second support 14. In this manner, the pacifier securing device 10 of the present invention is secured on the infant and the pacifier 20 can be inserted into the infant's mouth.

Varying the sequence of these steps is contemplated by alternative embodiments of the present invention. For example, referring again to FIGS. 1-4, in another embodiment, the pacifier 20 is secured to the first and second supports 12, 14 before the hat 23 is placed on the infant's head. In yet another embodiment, the pacifier 20 is fixedly connected to the first and second supports 12, 14 but the first and second supports 12, 14 are removably attached to the hat 23. According to this embodiment, the hat 12 may be placed on the infant's head either before or after the first and second supports 12, 14 are removably attached to the hat 23. In an additional embodiment, the pacifier 20 is fixedly attached to the first and second supports 12, 14, which are fixedly attached to the hat 23. In this embodiment, the hat 23 is fitted on the infant's head and then the first and second supports 12, 14 are stretched over the infant's face such that the pacifier 20 can be inserted into the infant's mouth thereby securing the pacifier securing device 10 on the infant.

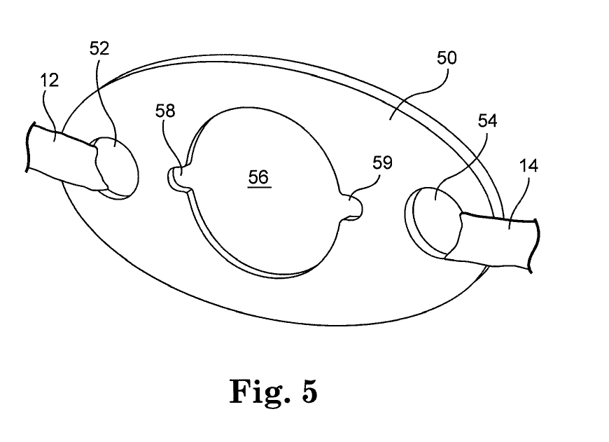

In each of the embodiments discussed above, the first and second supports or connecting straps 12, 14 are attached directly to the shield of the pacifier. As an alternative embodiment, the present invention may use a fastener or keeper which is design to be permanently attached to the pacifier securing device 10, while allowing the pacifier to be attached and removed as desired. In this matter, pacifiers can easily be changed to allow for easy washing, etc. Further, this allows the option of using the same pacifier without the securing device when desired. Referring to FIG. 5, a keeper or pacifier fastener 50 is illustrated which is capable of being removably attached to pacifier 20. As illustrated, first and second supports 12, 14 are attached to keeper 50 through respective connecting holes 52, 54. Additionally, keeper 50 includes a pacifier attachment opening 56 located in the center of the device, which is sized and configured to accommodate the attachment of pacifier 20. A pair of attachment slots 58, 59 are located on the side edges of opening 56 to further accommodate this attachment. As can be anticipated, the use of keeper 50 provides additional flexibility to the infant's parents when using the device. This also interferes less with the typical use of the pacifier 20 as the connection mechanism is positioned behind the pacifier shield, and not against the skin of the infant.

In this embodiment, keeper 50 is constructed of silicon material, thus allowing flexibility and easy attachment to pacifier 20. Further, supports 12, 14 are intended to be permanently attached to keeper 50 in order to provide a consistent attachment device which is always available. That said, removable attachment mechanisms could also be easily used.

Various other modifications and changes will be apparent to those of ordinary skill in the art without departing from the spirit and scope of the present invention. Applicant intends that these variations and modifications are included as part of the present invention and are not intended to be limiting. Further, Applicant does not intend the present application to be limited to only those embodiments outlined above or shown in the figures.

What is claimed is:

1. A securing device and pacifier for use by an infant, comprising:
a beanie cap having a head surrounding portion and a top portion sized and configured to be warn on the head of an infant;
a pair of chin strap attached to and extending from the beanie cap on two opposing sides thereof, the chin straps attachable to one another for placement under the chin of the infant thus holding the beanie cap in place;
a pacifier for use by an infant, the pacifier having a nipple portion and a shield portion, wherein the nipple portion is intended to be placed in an infant's mouth with the cooperating shield portion thereby being positioned around and outside the infant's mouth when used; and
a pair of connection straps attached also attached to the beanie cap at the two opposing sides thereof, adjacent to a point at which the chin straps attach to the beanie cap, the connection straps further extending to opposing side portions of the pacifier shield, wherein the connection straps are sized to loosely maintain the pacifier in a position adjacent the infant's mouth thereby making the pacifier continuously available to the infant.

2. The securing device and pacifier of claim 1 wherein the chin straps are attached to one another via a releasable attachment mechanism.

3. The securing device and pacifier of claim 1 wherein the cap, chin strap and connection straps are all made of a non-flammable material.

4. The securing device and pacifier of claim 1 wherein the chin straps and the connection straps are continuous material having a v-shaped configuration wherein the base of the v-shape is attached to the headband.

5. The securing device and pacifier of claim 2 wherein releasable attachment mechanism is cooperating hook-and-loop material.

6. The securing device and pacifier of claim 2 wherein releasable attachment mechanism is a snap.

7. The securing device and pacifier of claim 2 wherein releasable attachment mechanism is a button.

8. A pacifier securing device for use in holding a pacifier so it is accessible by an infant in close proximity to the infant's mouth, the pacifier securing device comprising:
a cap wearable by the infant having a headband portion which surrounds the infant's head and a top portion extending upwardly from the headband, the cap being created of a fabric type material of a selectable color and pattern;
a first connection strap attached to the headband portion at a first location and extending downwardly therefrom, the first connection strap fabricated of a fabric type material of a selectable color and pattern and having a pacifier connecting portion which is attached to the pacifier; and
a second connection strap attached to the headband portion at a second location which is on an opposite side of the headband portion from the first location, the second connection strap further extending downwardly from the headband and having a pacifier connecting portion which is attached to the pacifier on a side opposite the connection portion of the first connection strap, the second connection strap fabricated of a fabric type material of a selectable color and pattern.

9. The pacifier securing device of claim 8 wherein the first connection strap and the second connection strap further include connecting mechanisms for attachment to one another whereby the connection strap can be fastened beneath the infant's chin.

10. The pacifier securing device of claim 8 wherein the fabric materials forming the cap, first connection strap and second connection strap are each formed of flame resistant fabric material.

11. The pacifier securing device of claim 8 wherein the first connection strap and the second connection strap are elastic having predetermined stretching characteristics.

12. The pacifier securing device of claim 8 wherein the first connection strap and the second connection strap are attached to the pacifier via a pacifier keeper which is has a pacifier securing opening therein which is designed to hold the pacifier, wherein the first connection strap is attached to a first side of the keeper and the second attachment strap is connected to a second side of the keeper.

13. The pacifier securing device of claim 12 wherein the keeper is removably attachment to the first and second connection strap via a hook-and-loop material.

14. The pacifier securing device of claim 12 wherein the keeper is removably attachment to the first and second connection strap via a snap.

15. The pacifier securing device of claim 12 further comprising a pair of chin straps attached to the headband and releaseably attached to one another beneath the chin of the infant.

16. The pacifier securing device of claim 15 wherein the chin straps are formed of an elastic fabric having a predetermined characteristic of elasticity.

17. The pacifier securing device of claim 12 wherein the first connection strap and the second connection strap include chinstrap extensions releasably attachable to one another beneath the chin of the infant.

18. A pacifier holding device for using in holding a pacifier in a position to be easily accessible and in close proximity to an infant's mouth both when in use by the infant and when not in use by the infant, the pacifier holding device comprising:
a beanie cap having a headband surrounding the infant's head and a top portion extending upwardly from the headband to cover the infant's head, the beanie cap fabricated of an elastic type material having a predetermined elastic characteristic to closely fit the infant's head;
a pair of chin straps formed of elastic type material attached to the headband on opposite sides of the beanie cap and extending downwardly, the pair of chinstraps each having a connection end selectively connectable to one another at a position beneath the infant's chin; and
a pair of connection straps further attached to the headband at a position adjacent to the chin straps, the connection straps further having a pacifier connecting end selectively connectable to a shield portion of the pacifier at opposite sides thereof, the connection straps further formed of an elastic type material having a selected elastic characteristic, wherein the pair of connection straps are positioned to extend downwardly from the headband along the cheeks of the infant to the sides of the pacifier shield.

19. The pacifier holding device of claim 18 wherein the pair of chin straps and the pair of connection straps are fixedly attached to the headband and each of the selectable connections are achieved via a hook-and-loop connection material.

20. The pacifier holding device of claim 19 wherein each of the pair of connection straps and the pair of chin straps are continuous thus forming a v-shaped segment with the base of the v-shaped segment attached to the headband.
